(19) United States
(12) Patent Application Publication
(10) Pub. No.: US 2022/0337974 A1
(43) Pub. Date: Oct. 20, 2022

(54) SWITCHING DETERMINATION DEVICE, SWITCHING DETERMINATION METHOD, AND SWITCHING DETERMINATION PROGRAM

(71) Applicant: NIPPON TELEGRAPH AND TELEPHONE CORPORATION, Tokyo (JP)

(72) Inventors: Keihiro OCHIAI, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/761,032

(22) PCT Filed: Sep. 18, 2019
(86) PCT No.: PCT/JP2019/036561

§ 371 Date: Mar. 16, 2022

(51) Int. Cl. H04W 4/029; H04W 4/02; H04W 4/80

(52) U.S. Cl. CPC H04W 4/029; H04W 4/026; H04W 4/80; H04W 84/12

(57) ABSTRACT

A switching determination device includes: an input unit configured to receive an input of time-series data obtained by continuously receiving radio signals; a continuity counting unit configured to compare a value of the input time-series data at a first time count with a value of the input time-series data at a second time count just before the first time count, and increment a continuity counter value in a case in which the value of the input time-series data at the first time count and the value of the input time-series data at the second time count conform to each other, or reset the continuity counter value in a case in which the value of the input time-series data at the first time count and the value of the input time-series data at the second time count do not conform to each other; and a retention value output unit configured to set a value of the input time-series data at a time count at which the continuity counter value becomes equal to or greater than a threshold value as a retention value and output the retention value until the next time the continuity counter value becomes equal to or greater the threshold value.

### TECHNICAL FIELD

Techniques disclosed herein relate to a switching determination device, a switching determination method, and a switching determination program.

### BACKGROUND ART

There are techniques for estimating positions by mobile terminals such as smartphones receiving radio waves emitted from each Bluetooth (trade name) low energy (BLE) beacon in an environment in which a large number of BLE beacons are placed (see NPL 1, for example). According to the techniques, it is possible to obtain time-series data using the mobile terminals by receiving beacon IDs included in the radio waves from various BLE beacons one after another.

### CITATION LIST

### Non Patent Literature

NPL 1: Daisuke Sato, Hisako Shiohara, Masaru Miyamoto, Naonori Ueda, “People Flow Prediction Technology for Crowd Navigation”, NTT Technical Review, June 2018, Internet (URL: http://www/ntt.co.jp/journal/1806/files/JN20180638.pdf, referenced Aug. 15, 2019)

### SUMMARY OF THE INVENTION

### Technical Problem

Intensity of radio waves emitted from emission sources such as BLE beacons, Wi-Fi (trade name) access points, and artificial satellites in satellite positioning systems is not constant and may change with time. Thus, in environments in which a large number of radio wave emission sources are present, information of time-series data may irregularly vary in short periods of time. If the information of the time-series data irregularly varies in short periods of time, it becomes difficult to determine timings at which the information is switched, and for example, determination of the positions of the mobile terminals is affected.

The techniques disclosed herein were made in view of the aforementioned circumstances, and an object thereof is to provide a switching determination device, a switching determination method, and a switching determination program that enable precise determination of a timing at which information is switched through monitoring of input time-series data.

### Means for Solving the Problem

According to a first aspect of the present disclosure, a switching determination device includes: an input unit configured to receive an input of time-series data obtained by continuously receiving radio signals; a continuity counting unit configured to compare a value of the input time-series data at a first time count with a value of the input time-series data at a second time count just before the first time count, and increment a continuity counter value in a case in which the value of the input time-series data at the first time count and the value of the input time-series data at the second time count conform to each other, or reset the continuity counter value in a case in which the value of the input time-series data at the first time count and the value of the input time-series data at the second time count do not conform to each other; and a retention value output unit configured to set a value of the input time-series data at a time count at which the continuity counter value becomes equal to or greater than a threshold value as a retention value and output the retention value until the next time the continuity counter value becomes equal to or greater the threshold value.

According to a second aspect of the present disclosure, a switching determination method is provided in which a computer executes processing of: receiving an input of time-series data obtained by continuously receiving radio signals; comparing a value of the input time-series data at a first time count with a value of the input time-series data at a second time count just before the first time count, and incrementing a continuity counter value in a case in which the value of the input time-series data at the first time count and the value of the input time-series data at the second time count conform to each other, or resetting the continuity counter value in a case in which the value of the input time-series data at the first time count and the value of the input time-series data at the second time count do not conform to each other; and setting a value in the input time-series data at a time count at which the continuity counter value becomes equal to or greater than a threshold value as a retention value and outputting the retention value by tracing back to a time count that is continuously incremented until the threshold value is reached after the continuity counter value is reset.

According to a third aspect of the present disclosure, a switching determination program causes a computer to execute processing of: receiving an input of time-series data obtained by continuously receiving radio signals; comparing a value of the input time-series data at a first time count with a value of the input time-series data at a second time count just before the first time count, and incrementing a continuity counter value in a case in which the value of the input time-series data at the first time count and the value of the input time-series data at the second time count conform to each other, or resetting the continuity counter value in a case in which the value of the input time-series data at the first time count and the value of the input time-series data at the second time count do not conform to each other; and setting a value in the input time-series data at a time count at which the continuity counter value becomes equal to or greater than a threshold value as a retention value and outputting the retention value by tracing back to a time count that is continuously incremented until the threshold value is reached after the continuity counter value is reset.

### Effects of the Invention

According to the techniques disclosed herein, it is possible to precisely determine a timing at which information is switched through monitoring of time-series data input.

### BRIEF DESCRIPTION OF DRAWINGS

FIG. 1 is a block diagram illustrating a hardware configuration of a switching determination device according to an embodiment.

FIG. 2 is a block diagram illustrating an example of a functional configuration of the switching determination device.

FIG. 3 is a diagram for explaining effects of the switching determination device.

FIG. 4 is a diagram illustrating an environment in which a plurality of BLE beacons are placed.

FIG. 5 is a diagram illustrating an environment in which the plurality of BLE beacons are placed.

FIG. 6 is a diagram for explaining effects of the switching determination device.

FIG. 7 is a flowchart illustrating an example of a flow of switching determination processing performed by the switching determination device.

FIG. 8 is a diagram for explaining an example of the switching determination processing performed by the switching determination device.

FIG. 9 is a diagram for explaining the switching determination processing performed by the switching determination device.

FIG. 10 is a diagram for explaining the switching determination processing performed by the switching determination device.

FIG. 11 is a graph illustrating a temporal change between a bearing value and a bearing value after passage through a five-point FIR filter.

FIG. 12 is a graph illustrating switching determination in a traveling direction based on the switching determination processing performed by the switching determination device.

FIG. 13 is a diagram for explaining an example of the switching determination processing performed by the switching determination device.

FIG. 14 is a flowchart illustrating an example of a flow of the switching determination processing performed by the switching determination device.

FIG. 15 is a flowchart illustrating an example of a flow of the switching determination processing performed by the switching determination device.

FIG. 16 is a diagram for explaining processing of determining a sidewalk along which a user walks based on map matching.

FIG. 17 is a diagram for explaining the processing of determining the sidewalk along which the user walks based on the map matching.

FIG. 18 is a diagram for explaining the processing of determining the sidewalk along which the user walks based on the map matching.

FIG. 19 is a flowchart illustrating an example of a flow of the switching determination processing performed by the switching determination device.

FIG. 20 is a diagram for explaining the switching determination processing performed by the switching determination device.

FIG. 21 is a diagram for explaining the switching determination processing performed by the switching determination device.

### DESCRIPTION OF EMBODIMENTS

Hereinafter, an example of embodiments of the techniques disclosed herein will be described with reference to the drawings. In the drawings, the same reference signs are applied to the same or equivalent components and parts. The dimensional ratios in the drawings are exaggerated for convenience of explanation and may differ from actual ratios.

First, description will be given in regard to how embodiments of the techniques disclosed herein were achieved.

According to the techniques for estimating positions by mobile terminals such as smartphones receiving radio waves emitted from BLE beacons, it is possible to obtain time-series data using the mobile terminals by receiving beacon IDs included in the radio waves from the various BLE beacons one after another. However, there are cases in which values of time-series data vary unstably for some reason and it is not obvious which values are the proper values of the time-series data.

For example, consider a situation in which a mobile terminal receives radio waves emitted from each wireless device and determines which wireless device is located closest to the mobile terminal based on intensity of the received radio waves in an environment in which a large number of wireless devices that emit radio waves are placed. There are cases in which it is difficult to determine which wireless device is located the closest to the mobile terminal due to unstable variations in IDs of the wireless devices observed by the mobile terminal when people and the like walk at such a location.

One possible reason why the IDs of the wireless devices observed by the mobile terminal vary unstably is that the intensity of the radio waves is not constant. In other words, unstable variations in intensity of the radio waves emitted from the wireless devices are conceivable. Another conceivable reason why the IDs of the wireless devices observed by the mobile terminal vary unstably is that the emitted radio waves have some effect on environmental elements such as walls, persons, or the like. The radio waves emitted from the wireless devices may affect the environmental elements and may be reflected, diffracted, and attenuated. When the radio waves are received by the mobile terminal, direct waves from the wireless devices and the reflected waves, diffracted waves, or attenuated waves may be superimposed on each other. The radio wave intensity observed by the mobile terminal may thus become unstable. Also, in a case in which some wireless devices are placed indoors, radio wave intensity observed by the mobile terminal may become unstable due to presence of poles, complicated passage shapes, and the like.

Also, consider a situation in which a mobile terminal receives radio waves emitted from wireless devices placed at each floor of a building including a plurality of floors and determines on which floor the mobile terminal is present based on intensity of the received radio waves. For example, it may be difficult to determine the current floor in a case in which the mobile terminal can receive the radio waves transmitted from the wireless devices placed at floors above and below the current floor because the place is open to the outside to a high extent, like passages in an outer circumference of a stadium. Also, similar events may occur in department stores and the like near escalators or stairs.

For such reasons, intensity of radio waves from each wireless device observed by the mobile terminal varies more due to instability of the radio waves themselves or instability based on environmental elements than due to changes in observation position. Thus, it is not possible to reliably determine whether the wireless device emitting radio waves with the highest intensity is actually the closest wireless device merely by observing the intensity of the radio waves emitted from the wireless devices.

Also, values of a data series including observed position information vary unstably for various reasons. Cases are thus often observed where it becomes unclear which place is appropriate as a current place and which direction is appropriate as a traveling direction. For example, consider a case in which a mobile terminal such as a smartphone receives radio waves emitted from artificial satellites in a global navigation satellite system (GNSS) such as the Global Positioning System (GPS) and calculates a current position. In a so-called urban canyon environment in which there are many tall buildings, the buildings irregularly stand with some buildings blocking view of the sky. In the urban canyon environment, radio waves from the artificial satellites may thus be affected by blockage, reflection, diffraction, and the like of the buildings. As a result, the current position indicated by a position measurement result obtained by the mobile terminal varies irregularly or unstably, and a timing at which a traveling direction is switched (a timing of turning) is thus indeterminable.

Consider a case in which a position is estimated based on radio waves from BLE beacons or Wi-Fi (trade name) access points in an environment in which the BLE beacons, the Wi-Fi access points, or the like are placed in addition to or instead of artificial satellites. The current position indicated by the position measurement result of the smartphone or the like varies unstably due to instability of the radio waves and reflection, diffraction, attenuation, and the like of the radio waves due to shapes of structures such as walls of buildings in this case as well. A timing at which the smartphone or the like has entered a building or an underground passage thus becomes unclear.

Thus, a description of the present embodiment will be given about a technique that enables precise determination of a timing at which information is switched by outputting of values in states in which the variations are stable through monitoring of variations in values included in time-series data.

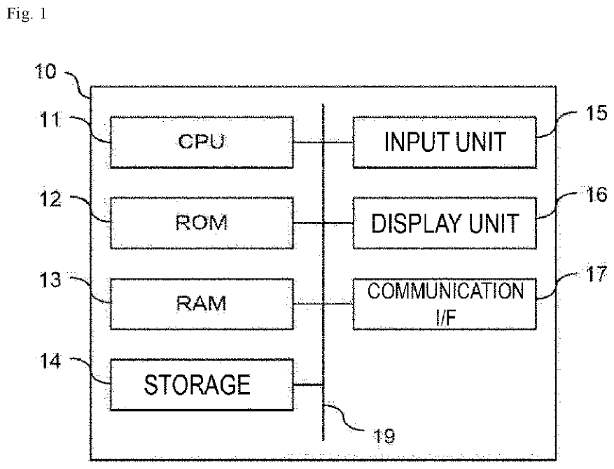

FIG. 1 is a block diagram illustrating a hardware configuration of a switching determination device 10 according to the present embodiment.

As illustrated in FIG. 1, the switching determination device 10 includes a central processing unit (CPU) 11, a read only memory (ROM) 12, a random access memory (RAM) 13, a storage 14, an input unit 15, a display unit 16, and a communication interface (I/F) 17. The components are communicably interconnected through a bus 19.

The CPU 11 is a central processing unit that executes various programs and controls each unit. In other words, the CPU 11 reads a program from the ROM 12 or the storage 14 and executes the program using the RAM 13 as a work area. The CPU 11 performs control of each of the components described above and various arithmetic processing operations in accordance with a program stored in the ROM 12 or the storage 14. In the present embodiment, the ROM 12 or the storage 14 stores a language processing program for converting audio input by the mobile terminal 20 into text.

The ROM 12 stores various programs and various kinds of data. The RAM 13 serves as a work area and temporarily stores programs or data. The storage 14 is configured with a storage device such as a hard disk drive (HDD) or a solid state drive (SSD) and stores various programs including an operating system and various kinds of data.

The input unit 15 includes a pointing device such as a mouse and a keyboard and is used for performing various inputs.

The display unit 16 is, for example, a liquid crystal display and displays various kinds of information. The display unit 16 may adopt a touch panel scheme and function as the input unit 15.

The communication interface 17 is an interface for communicating with other devices and uses standards such as, for example, Ethernet (trade name), FDDI, and Wi-Fi (trade name).

Next, a functional configuration of the switching determination device 10 will be described.

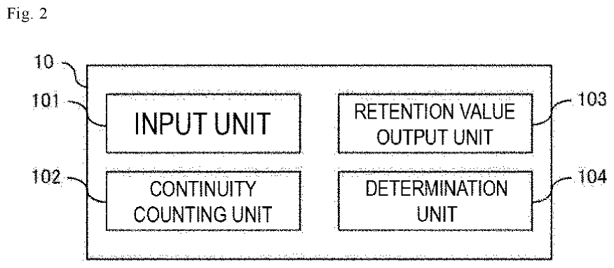

FIG. 2 is a block diagram illustrating an example of a functional configuration of the switching determination device 10. The switching determination device 10 according to the present embodiment may be provided inside a mobile terminal such as a smartphone.

As illustrated in FIG. 2, the switching determination device 10 includes, as functional configurations, an input unit 101, a continuity counting unit 102, a retention value output unit 103, and a determination unit 104. Each functional configuration is realized by the CPU 11 reading a switching determination program stored in the ROM 12 or the storage 14 and developing and executing the switching determination program in the RAM 13.

The input unit 101 receives an input of time-series data. The time-series data includes, for example, a predetermined value included in radio waves emitted from BLE beacons, wireless local area network (LAN) access points such as Wi-Fi (trade name) access points, or artificial satellites in a satellite positioning system. In the case of the BLE beacons, for example, the value of the time-series data is a beacon ID of a BLE beacon that has emitted radio waves with the strongest intensity.

The continuity counting unit 102 counts a continuity counter value based on the value of the time-series data input to the input unit 101. Specifically, the continuity counting unit 102 compares a value of the input time-series data at each time count with a value of the time-series data at a time count just before each time count. Then, the continuity counting unit 102 increments the continuity counter value by one in a case in which a predetermined condition is satisfied. On the other hand, the continuity counting unit 102 resets the continuity counter value to zero in a case in which the predetermined condition is not satisfied. The predetermined condition is that the value of the input time-series data at each time count is the same as the value of the time-series data at the time count just before each time count, for example. In this manner, the continuity counting unit 102 monitors variations in value of the time-series data input to the input unit 101.

The continuity counting unit 102 may count different continuity counter values depending on types of radio signals, which are basis of the time-series data input to the input unit 101. For example, consider a case in which the time-series data to be input to the input unit 101 is generated based on radio waves emitted from artificial satellites in a satellite positioning system and radio waves emitted from BLE beacons. In this case, the continuity counting unit 102 counts different continuity counter values when radio waves emitted from the artificial satellites are received and when radio waves emitted from the BLE beacons are received.

The retention value output unit 103 sets, as a retention value, a value of the time-series data at a time count at which the continuity counter value becomes equal to or greater than a threshold value. Then, the retention value output unit 103 outputs the retention value by tracing back to each time count at which the continuity counter value is continuously incremented until the threshold value is reached after the continuity counter value is reset. For example, in a case in which the threshold value is three, it is assumed that the continuity counter value is 0 at a timing of a time count t=N−3 and the continuity counter value is continuously incremented until a time count t=N. The retention value output unit 103 sets the value of the time-series data at the time count t=N as a retention value. Then, the retention value output unit 103 outputs the retention value by tracing back to the timing at the time count t=N−3. In this manner, the retention value output unit 103 can output a value in a state in which variations are stable.

The determination unit 104 performs various kinds of determination based on a result of processing performed by the continuity counting unit 102 on the continuity counter value.

For example, in a case in which the continuity counting unit 102 counts different continuity counter values in accordance with types of radio signals which are the basis of the time-series data input to the input unit 101, the determination unit 104 performs determination based on a result of processing performed on the different continuity counter values. For example, consider a case in which the time-series data to be input to the input unit 101 is generated based on radio waves emitted from artificial satellites in a satellite positioning system and radio waves emitted from BLE beacons. In this case, the determination unit 104 determines whether the radio waves have been received indoor or outdoor, based on the result of the processing performed by the continuity counting unit 102 on the different continuity counter values.

Also, the determination unit 104 determines where the wireless signals have been received based on the result of the processing performed by the continuity counting unit 102 on the different continuity counter values. Also, the determination unit 104 determines a change in traveling direction based on the result of the processing performed by the continuity counting unit 102 on the continuity counter value. In this case, the time-series data input to the input unit 101 may be generated based on the radio waves emitted from the artificial satellites in the satellite positioning system.

Next, effects of the switching determination device 10 will be described.

The switching determination device 10 according to the present embodiment outputs a value in a state in which variations are stable, through monitoring of variations in value included in the time-series data.

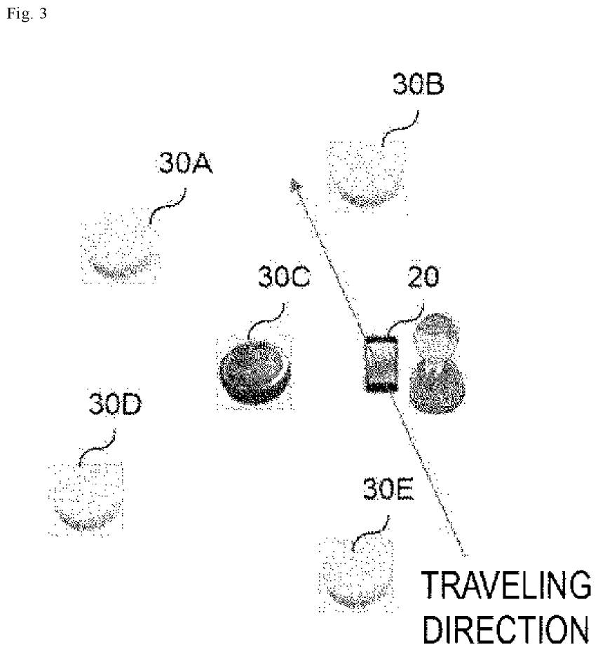

FIG. 3 is a diagram for explaining effects of the switching determination device 10. FIG. 3 illustrates an example in which a user carrying a mobile terminal 20 including the switching determination device 10 travels in a traveling direction. FIG. 3 also illustrates BLE beacons 30A to 30E. The mobile terminal 20 receives radio waves emitted from the BLE beacons 30A to 30E and identifies an ID of a BLE beacon that has emitted radio waves with the strongest radio wave intensity. Here, IDs of the BLE beacons 30A to 30E are defined as 1 to 5, respectively. Processes of the identified IDs for each time correspond to the time-series data.

In a case in which the user carrying the mobile terminal 20 moves in the traveling direction, unstable variations in intensity of radio waves emitted from the BLE beacons 30A to 30E may occur for the aforementioned various reasons. Thus, an irregular change in values of the time-series data input to the mobile terminal 20 such as “5, 3, 5, 5, 3, 5, 3, 3, 3, 4, 3, 5, 3, 3, 2, 2, 3” is assumed.

In a case in which the values of the time-series data can change irregularly, the switching determination device 10 outputs a retention value with which switching of the values of the time-series data becomes clear, such as “5, 5, 5, 5, 5, 5, 3, 3, 3, 3, 3, 3, 3, 3, 2, 2, 2”, for example.

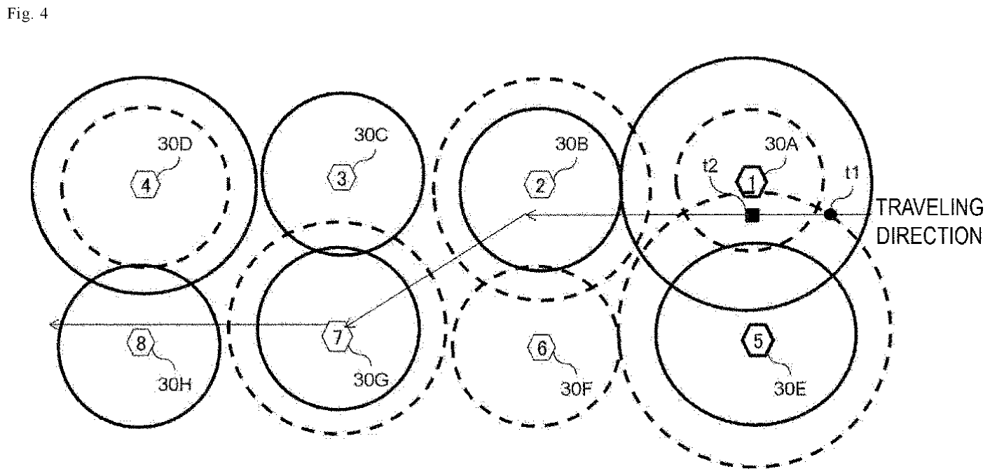

FIG. 4 is a diagram illustrating an environment in which a plurality of BLE beacons are placed. FIG. 4 illustrates an example in which a user advances in a traveling direction with a mobile terminal including the switching determination device 10. FIG. 4 also illustrates BLE beacons 30A to 30H. The mobile terminal receives radio waves emitted from the BLE beacons 30A to 30H and identifies an ID of a BLE beacon that has emitted radio waves with the strongest radio wave intensity. Here, IDs of the BLE beacons 30A to 30H are defined as 1 to 8, respectively. Processes of the identified IDs for each time correspond to the time-series data.

The solid line and dashed line circles illustrated in FIG. 4 illustrate variations in radio wave intensity of each BLE beacon. In a case in which the mobile terminal is placed at a location indicated by the reference sign t1 at a time count t=1, the mobile terminal determines that the radio wave intensity of the BLE beacon 30E is the highest if the radio wave intensity of each BLE beacon is in a state illustrated by the dashed line. Thus, the mobile terminal determines that the closest BLE beacon at the timing of the time count t=1 is the BLE beacon 30E.

Thereafter, in a case in which the mobile terminal is placed at a location indicated by the reference sign t2 at a time count t=2, the mobile terminal determines that the radio wave intensity of the BLE beacon 30A is the highest if the radio wave intensity of each BLE beacon is in the state illustrated by the solid line. Thus, the mobile terminal determines that the closest BLE beacon at the timing of the time count t=2 is the BLE beacon 30A. In this manner, the radio wave intensity of each BLE beacon is not constant, and radio waves emitted from the closest BLE beacon may not be indicated as the highest radio wave intensity in the mobile terminal even though the actual distance is the closest to the mobile terminal.

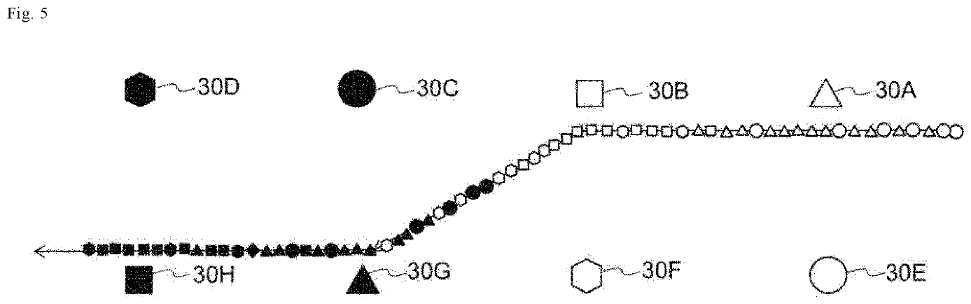

FIG. 5 is a diagram illustrating an environment in which a plurality of BLE beacons are placed. The diagram illustrates BLE beacons showing the highest radio wave intensity at each position when a user advances in a traveling direction with a mobile terminal in a state in which the BLE beacons are placed as in FIG. 4. FIG. 5 illustrates the BLE beacons 30A to 30H with mutually different shapes. In FIG. 5, the BLE beacons observed to have the highest radio wave intensity by the mobile terminal are illustrated in the traveling direction with the shapes corresponding to the BLE beacons 30A to 30H. In a case in which the user carrying the mobile terminal moves in the traveling direction, the intensity of the radio waves emitted from the BLE beacons 30A to 30H may vary unstably for the aforementioned various reasons. Thus, the BLE beacons exhibiting the highest radio wave intensity in the mobile terminal that receives the radio waves may be different even at adjacent locations as illustrated in FIG. 5.

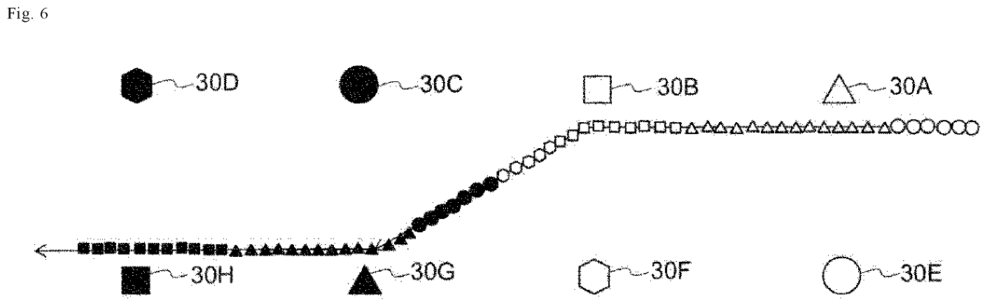

FIG. 6 is a diagram for explaining effects of the switching determination device 10. FIG. 6 illustrates the BLE beacons 30A to 30H with mutually different shapes similarly to FIG. 5. An object of the switching determination device 10 is to output such a retention value that switching of values in the time-series data becomes clear as illustrated in FIG. 6 in a case in which intensity of the radio waves emitted from the BLE beacons 30A to 30H can vary unstably as illustrated in FIG. 5. As illustrated in FIG. 6, the mobile terminal including the switching determination device 10 can stably determine the closest BLE beacon by outputting the retention value with which switching of the values in the time-series data becomes clear.

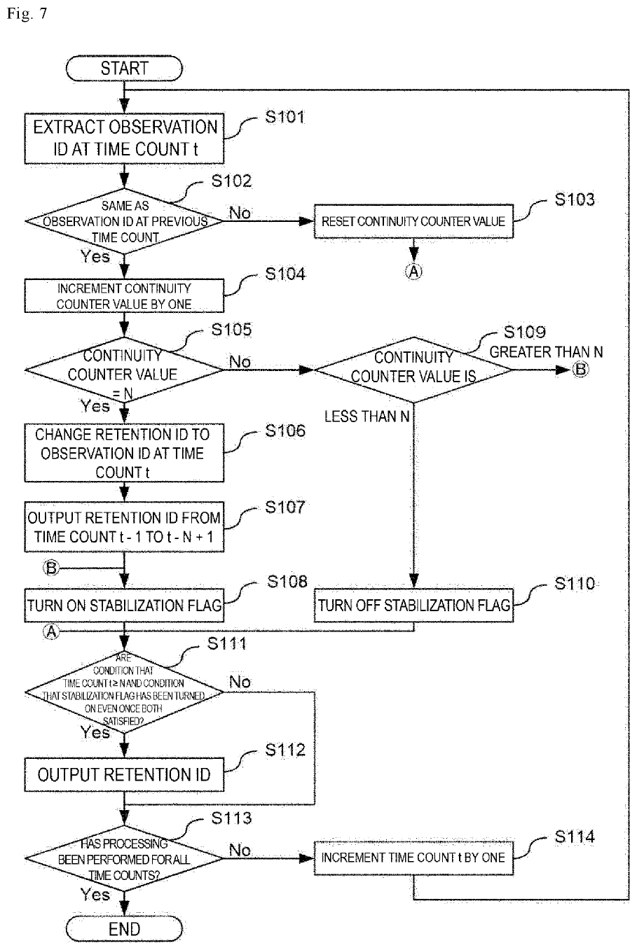

FIG. 7 is a flowchart illustrating an example of a flow of the switching determination processing performed by the switching determination device 10. The switching determination processing is performed by the CPU 11 reading the switching determination program from the ROM 12 or the storage 14 and developing and executing the switching determination program in the RAM 13.

The CPU 11 extracts an observation ID of the input time-series data at a time count t (Step S101). An initial value of t is defined as zero. In a case in which the input time-series data includes IDs of the BLE beacons, the observation ID is an ID of the BLE beacon exhibiting the highest radio wave intensity at the time of reception.

After Step S101, the CPU 11 determines whether the observation ID extracted in Step S101 is the same as an observation ID extracted at the previous time count (Step S102). If the observation ID extracted in Step S101 is not the same as the observation ID extracted at the previous time count (Step S102: No), then the CPU 11 resets the continuity counter value to zero (Step S103). Processing after Step S103 will be described later. On the other hand, if the observation ID extracted in Step S101 is the same as the observation ID extracted at the previous time count (Step S102: Yes), then the CPU 11 increments the continuity counter value by one (Step S104).

After Step S104, the CPU 11 determines whether the continuity counter value is equal to a predetermined threshold value N (Step S105). If the continuity counter value is equal to the predetermined threshold value N (Step S105: Yes), the CPU 11 changes the retention ID to the observation ID at the time count t (Step S106). The retention ID is an example of the retention value. After Step S106, the CPU 11 outputs the retention ID from a time count t−1 to t−N+1 (Step S107). After Step S107, the CPU 11 sets a stabilization flag to ON (Step S108). A value corresponding to ON of the stabilization flag is, for example, 1.

If the continuity counter value is not equal to the predetermined threshold value N as a result of the determination in Step S105 (Step S105: No), the CPU 11 determines whether the continuity counter value is greater than the predetermined threshold value N (Step S109). In a case in which the continuity counter value is greater than the predetermined threshold value N, the CPU 11 sets the stabilization flag to ON (Step S108). On the other hand, in a case in which the continuity counter value is less than the predetermined threshold value N, the CPU 11 sets the stabilization flag to OFF (Step S110). A value corresponding to OFF of the stabilization flag is, for example, 0.

After Step S103, Step S108, or Step S110, the CPU 11 determines whether the time count t is equal to or greater than the predetermined threshold value N and whether the stabilization flag has been turned on even once (Step S111). If the time count t is equal to or greater than the predetermined threshold value N, and the stabilization flag has been turned on even once (Step S111: Yes), the CPU 11 outputs the retention ID (Step S112). On the other hand, if the time count t is less than the predetermined threshold value N, or if the time count t is equal to or greater than the threshold value N and the stabilization flag has not been turned on even once (Step S111: No), the CPU 11 skips the processing in Step S112 because no retention ID is present.

After Step S111 or Step S112, the CPU 11 determines whether processing for all the time counts in the time-series data has been done (Step S113). If the processing for all the time counts in the time-series data has been done (Step S113: Yes), the CPU 11 ends the series of processes. On the other hand, if the processing for all the time counts in the time-series data has not been done (Step S113: No), the CPU 11 increments the time count t by one (Step S114). After Step S114, the CPU 11 returns to the processing of extracting the observation ID of the input time-series data at the time count tin Step S101.

The switching determination device 10 can stably determine a timing at which the values are switched from the input time-series data by executing the series of operations illustrated in FIG. 7. The switching determination device 10 can stably determine the timing at which the values are switched and can thus contribute to accurate determination of the current position, for example.

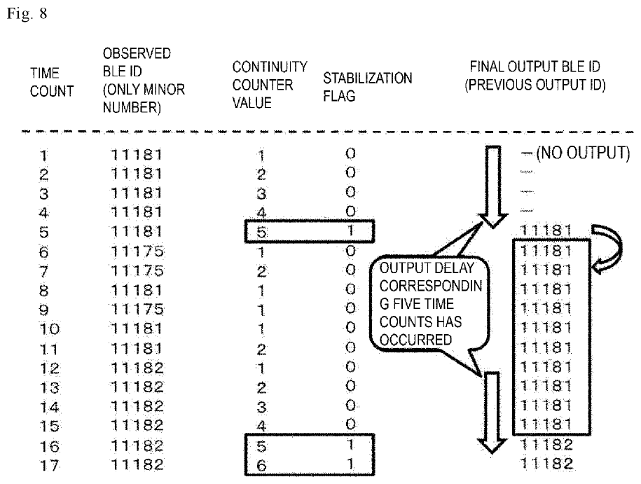

FIG. 8 is a diagram for explaining an example of the switching determination processing performed by the switching determination device 10. FIG. 8 illustrates time counts, an ID of a BLE beacon acquired by the switching determination device 10 at each time count, a continuity counter value, a stabilization flag, and an ID of a BLE beacon finally output by the switching determination device 10. Note that in the example of the determination processing illustrated in FIG. 8, the switching determination device 10 omits Step S107 described above and does not output an ID by tracing back the time.

In the example illustrated in FIG. 8, the threshold value N is defined as five. At a time count t=1 to 5, all the IDs of the BLE beacons acquired by the CPU 11 are “11181” and are the same. Thus, the CPU 11 sets the stabilization flag to 1 (ON) at the timing of the time count t=5 and outputs the ID “11181” of the BLE beacon. Because the ID of the BLE beacon acquired at the following timing of the time count t=6 becomes a value that is different from the ID at the previous time count, the CPU 11 sets the stabilization flag to 0 (OFF). However, there is no change in ID of the BLE beacon to be output. Although the IDs of the BLE beacons slightly change thereafter, the CPU 11 curbs unstable switching of the output values and continuously outputs “11181”, which is the ID of the BLE beacon at the timing of the time count t=5.

Thereafter, all the IDs of the BLE beacons acquired by the CPU 11 become “11182” and are the same at a time count t=12 to 16. Then, the CPU 11 sets the stabilization flag to 1 (ON) at the timing of the time count t=16. Then, the CPU 11 switches the output of the ID of the BLE beacon from “11181” to “11182” at the timing of the time count t=16.

Because the threshold value N is 5 in the example illustrated in FIG. 8, the stabilization flag is set to 1 (ON) for the first time at a timing at which the same ID of the BLE beacon continues five times, and the ID of the BLE beacon is output. Thus, a delay corresponding to five time counts at minimum occurs in the output.

The CPU 11 can eliminate the delay by outputting the retained ID of the BLE beacon from the time count t−1 to the time count t−N+1 as in Step S107 in FIG. 7 at the timing at which the stabilization flag is set to 1 (ON).

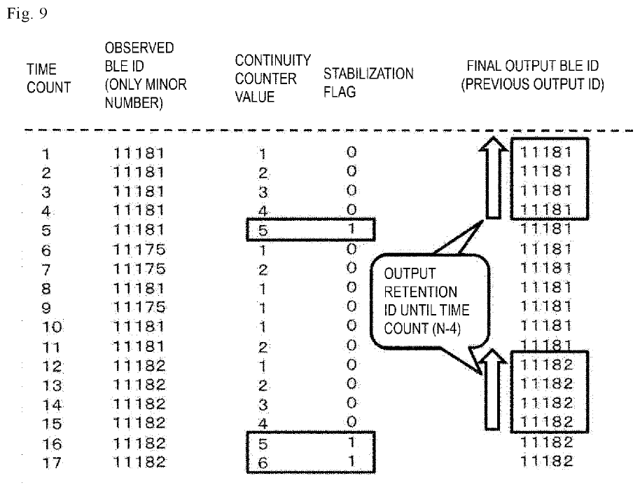

FIG. 9 is a diagram for explaining the switching determination processing performed by the switching determination device 10. FIG. 9 illustrates a time count, an ID of a BLE beacon acquired by the switching determination device 10 at each time count, a continuity counter value, a stabilization flag, and an ID of a BLE beacon finally output by the switching determination device 10. The threshold value N is defined as five similarly to the example in FIG. 8. In the example of the determination processing illustrated in FIG. 9, the switching determination device 10 performs Step S107 and outputs the ID by tracing back the time as in the determination processing illustrated in FIG. 7.

In the example in FIG. 9, the CPU 11 sets the stability flag to 1 (ON) at the timing of the time count t=5 similarly to the example in FIG. 8. Then, at this point, the CPU 11 traces back to the time count t=1 to 4 and outputs the ID “11181” of the BLE beacon as an output at the time count t=1 to 4.

In the example in FIG. 9, the CPU 11 sets the stabilization flag to 1 (ON) at the timing of the time count t=16 similarly to the example in FIG. 8. Then, at this timing, the CPU 11 traces back to the time count t=12 to 15 and outputs the ID “11182” of the BLE beacon as an output at the time count t=12 to 15. In other words, the ID “11181” of the BLE beacon is once output at the time count t=12 to 15, and the ID “11182” of the BLE beacon is overwritten at the time count t=16 at which stabilization of the ID “11182” of the BLE beacon is determined.

In this manner, it is possible to eliminate the delay in output in response to an input by the CPU 11 outputting the ID of the BLE beacon from the time count t−1 to the time count t−N+1 as in Step S107 in FIG. 7 at the timing at which the stabilization flag is set to 1 (ON).

Hereinafter, advantages of the switching determination device 10 will be described by exemplifying various use case examples.

Determination of Current Floor through Reception of Radio Waves

First, an example of determination regarding in which floor a place where radio signals have been received is from among a plurality of floors will be described. Consider a situation in which a mobile terminal receives radio waves emitted from wireless devices placed in each floor in a building including a plurality of floors and determination is made regarding which floor the mobile terminal is based on intensity of the received radio waves. In a case of a space opened to the outside, like outer peripheral passages of a stadium, for example, the mobile terminal can receive radio waves transmitted from the wireless devices placed in the floors above and below the current floor. Also, steps in a department store have an open-ceiling structure through upper to lower floors, for example, and the mobile terminal can receive radio waves transmitted from the wireless devices placed in floors above and below the current floor.

In such a case, the switching determination device 10 can stably determine the current floor through execution of the aforementioned switching determination processing.

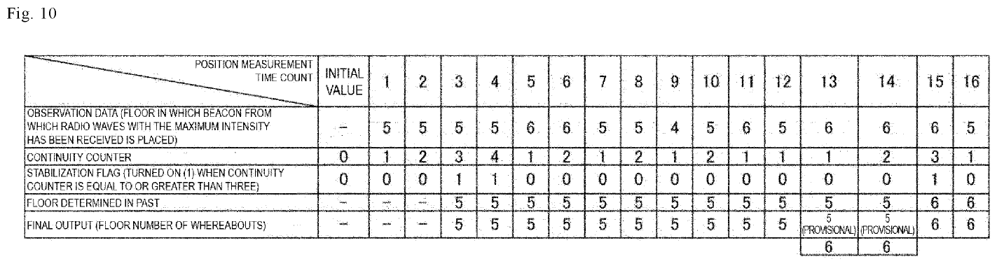

FIG. 10 is a diagram for explaining the switching determination processing performed by the switching determination device 10. FIG. 10 illustrates time-series change in observation data of radio waves emitted from BLE beacons or Wi-Fi (trade name) access points, a continuity counter value, a stabilization flag, a floor determined in the past, and a final output with elapse of positioning time count. The value of the observation data is a floor in which the BLE beacon or the Wi-Fi (trade name) access point from which radio waves with the maximum intensity has been received is placed.

In the example illustrated in FIG. 10, the threshold value N is defined as 3. In other words, the CPU 11 sets the stabilization flag to 1 (ON) if the value of the input observation data is the same three time counts straight.

As illustrated in FIG. 10, the observation data at all the positioning time counts 1 to 3 is “5” indicating the fifth floor. Thus, the CPU 11 sets the stabilization flag to 1 (ON) at the timing of the positioning time count 3. Then, the CPU 11 outputs “5” as a final output.

Thereafter, the value of the observation data changes from “5” indicating the fifth floor to “6” indicating the sixth floor at the timing of the positioning time count 6. At the timing at which the positioning time count 6, the CPU 11 resets the continuity counter value to one and sets the stabilization flag to 0 (OFF). However, the final output of the CPU 11 is still “5” at the timing of the positioning time count 6.

Thereafter, the value of the observation data slightly varies until the timing of the positioning time count 12. The values of the observation data do not become the same three times straight until the timing of the positioning time count 12. Thus, the final output of the CPU 11 is still “5” until the timing of the positioning time count 12.

Next, the observation data at all the positioning time counts 13 to 15 is “6”. Thus, the CPU 11 sets the stabilization flag to 1 (ON) at the timing of the positioning time count 15. Then, the CPU 11 traces back to the positioning time counts 13 and 14 at the timing of the positioning time count 15 and outputs “6” as a final output at each positioning time count.

In this manner, the switching determination device 10 can detect the timing at which the values of the observation data are switched and stabilize the value to be output, by determining the timing at which the same observation data is input N times straight as a timing of the switching.

In a case of an environment in which a large number of BLE beacons are placed, or an environment in which a BLE beacon is placed in each floor, for example, the switching determination device 10 can execute the switching determination processing and precisely detect the timing at which data has been switched. Not only in a case of moving through steps but also a case of moving across floors using an escalator, an elevator, or the like, the switching determination device 10 can execute the switching determination processing and precisely detect the timing at which data has been switched in a similar manner. Then, the switching determination device 10 can contribute to accurate determination of a current position or a current floor through precise detection of the timing at which the data has been switched.

There is a known technique of removing noise due to variations using a smoothing filter or a Kalman filter in a case in which the value of the input time-series data varies with elapse of time.

In a case in which a smoothing filter is used is used to remove noise from input time-series data, only a small amount of calculation is required, no prior processing is needed, wand real-time processing can be performed. On the other hand, in the case in which the smoothing filter is used to remove noise, switching of the data series after the filtering processing becomes further unclear. Thus, in a case in which the smoothing filter is used to remove noise when a position of a person is to be determined in an environment in which a large number of beacons are disposed on a two-dimensional plane, a beacon at an average position rather than the closest position may be selected. It is thus not possible to determine the position of the person in the case in which the smoothing filter is used.

In a case in which a Kalman filter is used to remove noise from input time-series data, a large amount of calculation is required, and model parameters have to be estimated in advance although real-time processing can be performed. In the case in which the Kalman filter is used to remove noise, switching of data series after the filtering processing becomes clear to some extent due to an advantage of the noise removal. In a case in which the Kalman filter is used to remove noise when a position of a person is determined in an environment in which a large number of beacons are disposed on a two-dimensional plane, it is possible to detect a rough position of the person. However, in the case in which the Kalman filter is used to remove noise, only the beacon at a relatively close location is selected, and it is not possible to select the closest beacon. In the case in which the Kalman filter is used to remove noise, it is difficult to construct a general walking model because people move in various ways.

As compared with these filters, the switching determination processing according to the present embodiment requires a small amount of calculation, does not need prior processing, and can be performed in real time. Moreover, according to the switching determination processing according to the present embodiment, switching of data series after the processing is clear. It is thus possible to select the closest beacon in accordance with the position and the movement of the person by applying the switching processing according to the present embodiment to the determination of the position of the person in an environment in which a large number of beacons are disposed on a two-dimensional plane.

Determination of Switching of Traveling Direction

The switching determination device 10 can stably detect a switching timing of input time-series data using outputs of time-series data from other devices as inputs. In a case in which it is desired to detect a traveling direction of a user, for example, it is difficult to detect a timing at which the user has actually turned, only from time-series data of the traveling direction that irregularly varies. In a case in which it is desired to detect a current position of the user, for example, it is difficult to identify the user going into or out of a building only from time-series data of position information that irregularly varies. The switching determination device 10 can stably detect a switching timing of the time-series data of the traveling direction or the position information using, as an input, time-series data of the traveling direction or time-series data of the position information. In this manner, the switching determination device 10 can contribute to identification of switching of the traveling direction by turning sideways or moving into or out of an entrance of a building or an underground shopping arcade.

As a method of stabilizing data, values of which significantly vary, a method using a finite impulse response (FIR) filter is known, for example. It is possible to calculate a current direction (bearing value) in addition to a current position, using data included radio waves emitted from artificial satellites in a satellite positioning system. In a case in which the bearing value significantly varies, a method of stabilizing the variations in bearing value through an FIR filter is conceivable.

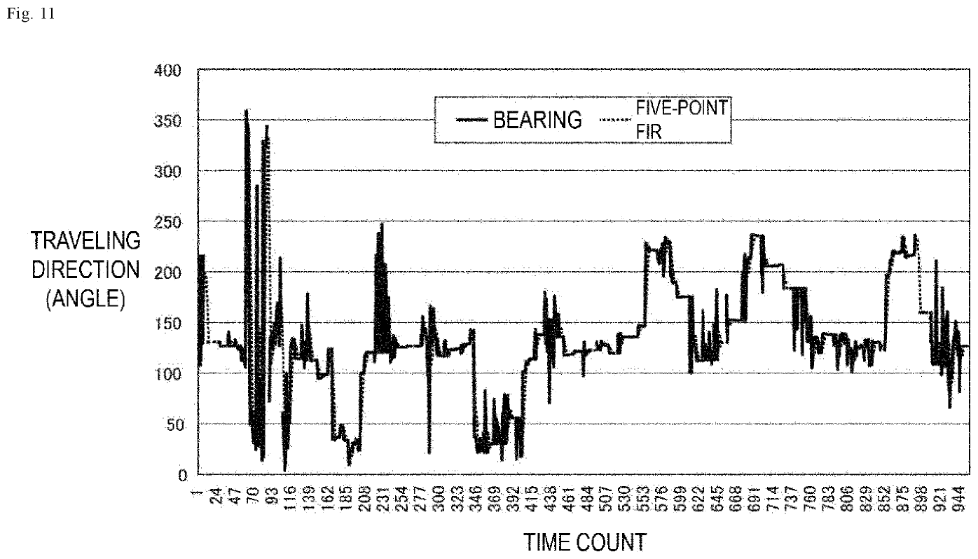

FIG. 11 is a graph illustrating a temporal change between a bearing value and a bearing value after passage through a five-point FIR filter. In this manner, it is difficult to curb influences of variations in bearing value even if the five-point FIR filter is used, in an environment in which the bearing value significantly varies.

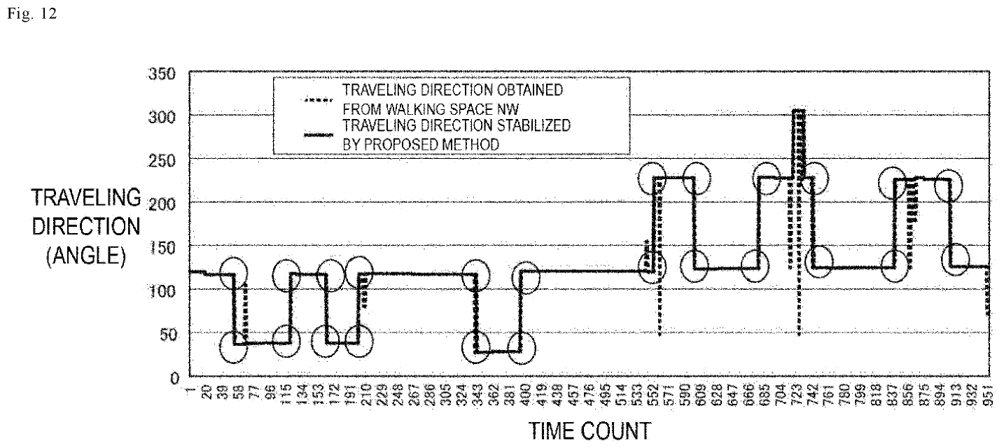

FIG. 12 is a graph illustrating switching determination of a traveling direction based on the switching determination processing performed by the switching determination device 10. It is difficult to detect a switching timing of the traveling direction only with the bearing value. Thus, a traveling direction of a walking space network that is parallel to the traveling direction obtained from the bearing value is extracted. In the switching determination processing performed by the switching determination device 10, a data switching timing is determined using the traveling direction of the walking space network as an input. The locations represented with the circles in the graph in FIG. 12 are locations at which the traveling direction is determined to have been switched. In this manner, the switching determination device 10 can stably determine the switching timing of the data. In other words, the switching determination device 10 can contribute to accurate determination of the switching timing of the traveling direction.

Determination of Moving Into and Out of Building or Underground Passage

Consider a case in which a current position is determined using a smartphone or the like through reception of radio waves from a satellite positioning system, BLE beacons, Wi-Fi (trade name) access points, or the like. In a case in which a current position is determined in such an environment, the current position indicated by a position measurement result obtained by the smartphone or the like unstably varies due to instability of radio waves and reflection, diffraction, attenuation, and the like of the radio waves due to shapes of structures such as building walls and the like. A timing at which the smartphone or the like has entered a building or an underground passage thus becomes unclear.

For example, it is possible to receive radio waves from a satellite positioning system, which arrives from an outdoor place, even at an indoor place near an entrance of a general building. On the contrary, radio waves can be received from BLE beacons or Wi-Fi (trade name) access points placed indoors even at an outdoor place. It is thus difficult to determine whether the current position is indoor or outdoor near a boundary of a building. For example, an entrance of an underground passage or an underground shopping arcade is opened to the outdoor space. Near the entrance of the underground passage or the underground shopping arcade, all radio waves from the satellite positioning system, the BLE beacons, and the Wi-Fi (trade name) access points can be received. Thus, it is not possible to distinguish which position the user is located near an entrance, and it is difficult to determine whether the current position is indoor or outdoor. Also, glass walls or doors, for example, are often used at entrances of highly public buildings. Near an entrance using a glass wall or door, both radio waves from a satellite positioning system from the outdoor space and radio waves from BLE beacons and Wi-Fi (trade name) access points placed in the indoor space are transmitted and received therethrough. Thus, there may be a case in which it is not possible to determine which position the user is located near the entrance using the glass wall or door and it is difficult to determine whether the current position is indoor or outdoor.

In such a case, it is possible to clearly determine whether the current position is indoor or outdoor using the switching determination processing performed by the switching determination device 10. Because it is possible to clearly determine whether the current position is indoor or outdoor, the switching determination device 10 can stably output the result of determining whether the current position is indoor or outdoor. In the present embodiment, the switching determination device 10 performs the switching determination using the following criteria.

For example, let the following case be a criterion for determining that the user is staying outdoor: radio waves emitted from the satellite positioning system have been received three times straight. The following description will be given on the assumption that the satellite positioning system is a GPS. The switching determination device 10 sets an outdoor determination flag to 1 and sets an indoor determination flag to 0 if the user is determined to be staying outdoor. Then, let the following case be a criterion for determining that the user is staying indoor: radio waves emitted from a BLE beacon or a Wi-Fi (trade name) access point has been received even once is defined. The switching determination device 10 sets the outdoor determination flag to 0 and sets the indoor determination flag to 1 if the user is determined to be staying indoor. After the user is determined to be staying indoor, the switching determination device 10 discards a positioning result obtained by the satellite positioning system observed until the user is determined to be staying outdoor. The switching determination device 10 outputs the other positioning results in accordance with the determination regarding whether the current position is indoor or outdoor.

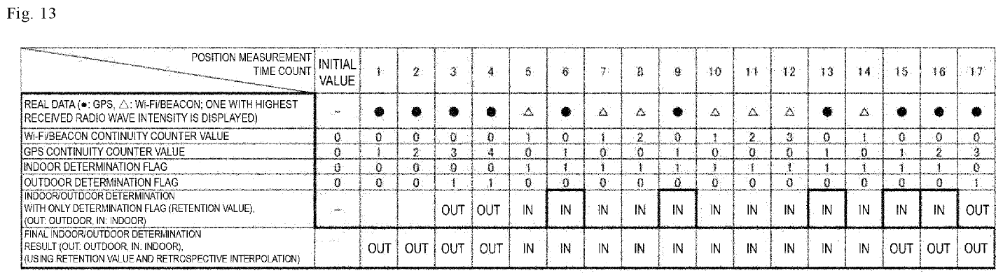

FIG. 13 is a diagram for explaining an example of the switching determination processing performed by the switching determination device 10. FIG. 13 illustrates time-series changes in actual data (observation data of radio waves emitted from a satellite positioning system such as a GPS or BLE beacons or Wi-Fi (trade name) access points), a Wi-Fi (trade name)/beacon continuity counter value, a GPS continuity counter value, an indoor determination flag, an outdoor determination flag, indoor/outdoor determination using only a determination flag (retention value), and a final result of indoor/outdoor determination with elapse of a positioning time count. The Wi-Fi (trade name)/beacon continuity counter value and the GPS continuity counter value are examples of the different continuity counter values according to the present disclosure.

As illustrated in FIG. 13, actual data at all the positioning time counts 1 to 3 is data from the satellite positioning system. Thus, the CPU 11 sets the outdoor determination flag to 1 at the timing of the positioning time count 3. Then, the CPU 11 outputs “OUT” as the indoor/outdoor determination result. The determination “OUT” is made for the first time at the timing of the positioning time count 3 according to the indoor/outdoor determination result using only the determination flag. Here, the CPU 11 performs interpolation by tracking back to the timing of the positioning time counts 1 and 2 and outputs “OUT” as the indoor/outdoor determination result.

At the following timing of the positioning time count 5, the actual data is data from a BLE beacon or a Wi-Fi (trade name) access point. Thus, the CPU 11 sets the outdoor determination flag to 0 and sets the indoor determination flag to 1 at the timing of the positioning time count 5. Then, the CPU 11 outputs “IN” as the indoor/outdoor determination result. The CPU 11 discards the data from the satellite positioning system because the indoor determination flag has been changed to 1.

Thereafter, the value of the observation data slightly varies until the timing of the positioning time count 14. Until the timing of the positioning time count 14, data from the satellite positioning system has not been observed three times straight. Thus, the CPU 11 outputs “IN” as the indoor/outdoor determination result at a time count at which data from the BLE beacon or the Wi-Fi (trade name) access point is observed until the timing of the positioning time count 14.

Thereafter, actual data at all the positioning time counts 15 to 17 is data from the satellite positioning system. Thus, the CPU 11 sets the outdoor determination flag to 1 and sets the indoor determination flag to 0 at the timing of the positioning time count 17. Then, the CPU 11 outputs “OUT” as the indoor/outdoor determination result. Determination of “OUT” is made for the first time at the timing of the positioning time count 17 according to the indoor/outdoor determination result using only the determination flag. Here, the CPU 11 performs interpolation by tracing back to the timing of the positioning time counts 15 and 16 and outputs “OUT” as the indoor/outdoor determination result.

In the case where whether the user is staying indoor or outdoor is determined, the switching determination device 10 executes switching determination processing with reception of radio waves from a GPS and switching determination processing with reception of radio waves from a BLE beacon or a Wi-Fi (trade name) access point, which will be described later, in parallel.

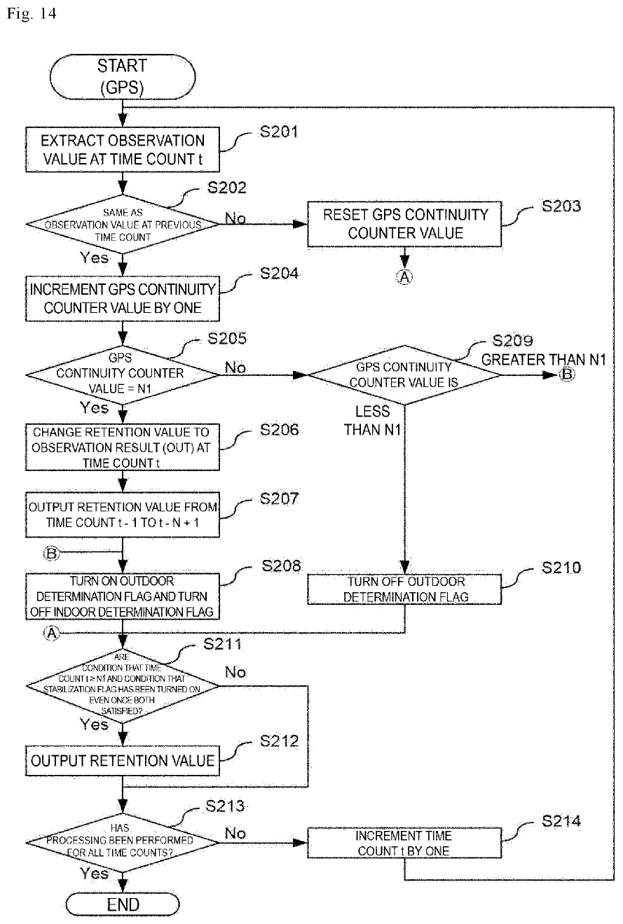

FIG. 14 is a flowchart illustrating an example of a flow of the switching determination processing performed by the switching determination device 10. The switching determination processing is performed by the CPU 11 reading the switching determination program from the ROM 12 or the storage 14 and developing and executing the switching determination program in the RAM 13.

The processing illustrated in FIG. 14 is switching determination processing with reception of the radio waves emitted from the GPS. The CPU 11 extracts an observation value of input time-series data at a time count t (Step S201). An initial value oft is defined as zero. Here, the input time-series data includes information indicating which of the GPS or the BLE beacon or the Wi-Fi (trade name) access point the radio waves have been emitted from.

After Step S201, the CPU 11 determines whether or not the observation value extracted in Step S201 is the same as an observation value extracted at the previous time count, that is, both the observation values are information indicating the radio waves emitted from the GPS (Step S202). If the observation value extracted in Step S201 is not the same as the observation value extracted at the previous time count (Step S202: No), the CPU 11 resets the GPS continuity counter value to zero (Step S203). Processing after Step S203 will be described later. On the other hand, if the observation value extracted in Step S201 is the same as the observation value extracted at the previous time count (Step S202: Yes), the CPU 11 increments a GPS continuity counter value by one (Step S204).

After Step S204, the CPU 11 determines whether or not the GPS continuity counter value is equal to a predetermined threshold value N1 (Step S205). If the GPS continuity counter value is equal to the predetermined threshold value N1 (Step S205: Yes), the CPU 11 changes the retention value to a value corresponding to the observation value at the time count t, that is, “OUT” (Step S206). After Step S206, the CPU 11 outputs the retention value from the time count t−1 to the time count t−N1+1 (Step S207). After Step S207, the CPU 11 sets the outdoor determination flag to ON and sets the indoor determination flag to OFF (Step S208). The value corresponding to ON of each flag is 1, for example, and the value corresponding to OFF is, for example, 0.

If the GPS continuity counter value is not equal to the predetermined threshold value N1 as a result of the determination in Step S205 (Step S205: No), the CPU 11 determines whether the GPS continuity counter value is greater than the predetermined threshold value N1 (Step S209). In a case in which the GPS continuity counter value is greater than the predetermined threshold value N1, the CPU 11 sets the outdoor determination flag to ON and sets the indoor determination flag to OFF (Step S208). On the other hand, in a case in which the GPS continuity counter value is less than the predetermined threshold value N1, the CPU 11 sets the outdoor determination flag to OFF (Step S210).

After Step S203, Step S208, or Step S210, the CPU 11 determines whether the time count t is equal to or greater than the predetermined threshold value N1 and whether the stabilization flag has been turned on even once (Step S211). If the time count t is equal to or greater than the predetermined threshold value N1 and the stabilization flag has been turned on even once (Step S211: Yes), the CPU 11 outputs the retention value (Step S212). On the other hand, if the time count t is less than the predetermined threshold value N1 or if the time count t is equal to or greater than the predetermined threshold value N1 and the stabilization flag has not been turned on even once (Step S211: No), the CPU 11 skips the processing in Step S212 because no retention value is present.

After Step S211 or Step S212, the CPU 11 determines whether the processing for all the time counts in the time-series data has been done (Step S213). If the processing for all the time counts in the time-series data has been done (Step S213: Yes), the CPU 11 ends the series of processes. On the other hand, if the processing for all the time counts in the time-series data has not been done (Step S213: No), the CPU 11 increments the time count t by one (Step S214). After Step S214, the CPU 11 returns to the processing of extracting the observation value at the time count t in the input time-series data in Step S201.

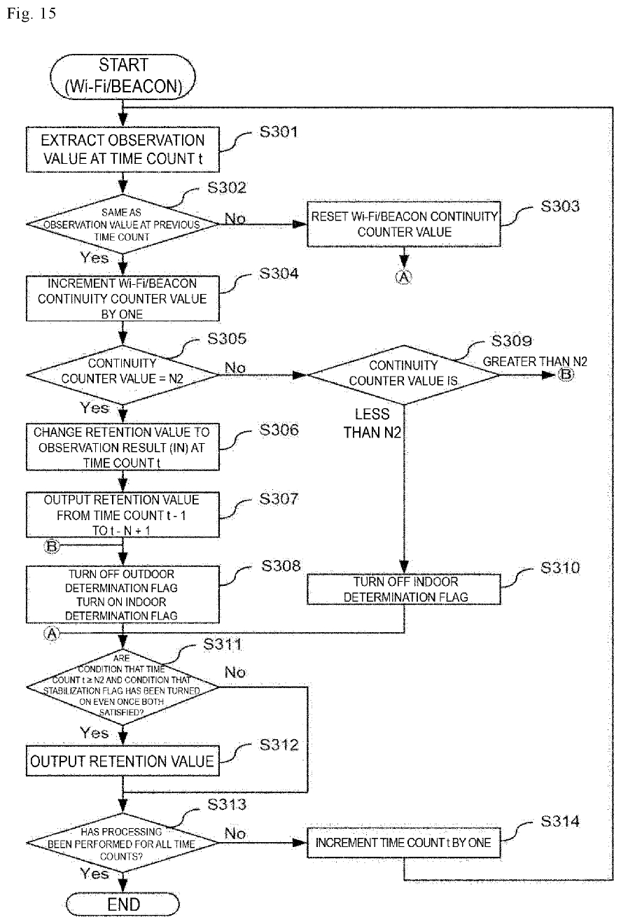

FIG. 15 is a flowchart illustrating an example of a flow of the switching determination processing performed by the switching determination device 10. The switching determination processing is performed by the CPU 11 reading the switching determination program from the ROM 12 or the storage 14 and developing and executing the switching determination program in the RAM 13.

The processing illustrated in FIG. 15 is switching determination processing with reception of radio waves emitted from a BLE beacon or a Wi-Fi (trade name) access point. The CPU 11 extracts an observation value of the input time-series data at the time count t (Step S301). An initial value oft is defined as zero. Here, the input time-series data includes information indicating which of the GPS or the BLE beacon or the Wi-Fi (trade name) access point the radio waves have been emitted from.

After Step S301, the CPU 11 determines whether the observation value extracted in Step S301 is the same as an observation value extracted at the previous time count, that is, both the observation values are information indicating radio waves emitted from the BLE beacon or the Wi-Fi (trade name) access point (Step S302). If the observation value extracted in Step S301 is not the same as the observation value extracted at the previous time count (Step S302: No), the CPU 11 resets a Wi-Fi (trade name)/beacon continuity counter value to zero (Step S303). Processing after Step S303 will be described later. On the other hand, if the observation value extracted in Step S301 is the same as the observation value extracted at the previous time count (Step S302: Yes), the CPU 11 increments the Wi-Fi (trade name)/beacon continuity counter value by one (Step S304).

After Step S304, the CPU 11 determines whether or not the Wi-Fi (trade name)/beacon continuity counter value is equal to a predetermined threshold value N2 (Step S305). If the Wi-Fi (trade name)/beacon continuity counter value is equal to the predetermined threshold value N2 (Step S305: Yes), the CPU 11 changes the retention value to a value corresponding to the observation value at the time count t, that is, “IN” (Step S306). After Step S306, the CPU 11 outputs the retention value from a time count t−1 to a time count t−N2+1 (Step S307). After Step S307, the CPU 11 sets the indoor determination flag to ON and sets the outdoor determination flag to OFF (Step S308). The value corresponding to ON of each flag is 1, for example, and the value corresponding to OFF is, for example, 0.

If the Wi-Fi (trade name)/beacon continuity counter value is not equal to the predetermined threshold value N2 (Step S305: No) as a result of the determination in Step S305, the CPU 11 determines whether or not the Wi-Fi (trade name)/beacon continuity counter value is greater than the predetermined threshold value N2 (Step S309). In a case in which the Wi-Fi (trade name)/beacon continuity counter value is greater than the predetermined threshold value N2, the CPU 11 sets the indoor determination flag to ON and sets the outdoor determination flag to OFF (Step S308). On the other hand, in a case in which the Wi-Fi (trade name)/beacon continuity counter value is less than the predetermined threshold value N2, the CPU 11 sets the indoor determination flag to OFF (Step S310).

After Step S303, Step S308, or Step S310, the CPU 11 determines whether the time count t is equal to or greater than the predetermined threshold value N2 and whether the stabilization flag has been turned on even once (Step S311). If the time count t is equal to or greater than the predetermined threshold value N2, and the stabilization flag has been turned on even once (Step S311: Yes), the CPU 11 outputs the retention value (Step S312). On the other hand, if the time count t is less than the predetermined threshold value N2, or if the time count t is equal to or greater than the predetermined threshold value N2 and the stabilization flag has not been turned on even once (Step S311: No), the CPU 11 skips the processing in Step S312 because no retention value is present.

After Step S311 or Step S312, the CPU 11 determines whether processing at all the time counts in the time-series data has been done (Step S313). If the processing at all the time counts in the time-series data has been done (Step S313: Yes), the CPU 11 ends the series of processes. On the other hand, if the processing at all the time counts in the time-series data has not been done (Step S313: No), the CPU 11 increments the time count t by one (Step S314). After Step S314, the CPU 11 returns to the processing of extracting the observation value at the time count t in the input time-series data in Step S301.

As described above, the switching determination device 10 can appropriately determine whether the user is staying indoor or outdoor, in accordance with the reception state of the radio waves.

Determination of Walking Passage

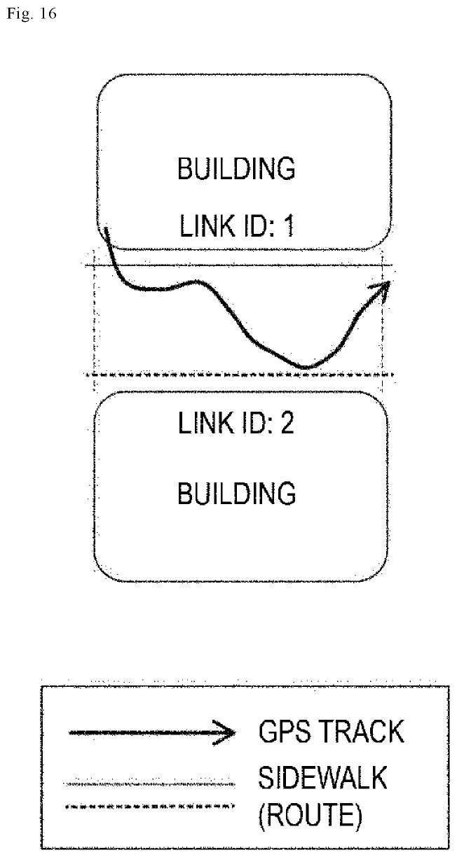

Consider a case in which radio waves emitted from a satellite positioning system are received by a mobile terminal such as a smartphone to obtain a current position and which of sidewalks at both ends of a road a user is walking is determined through map matching performed on the current position. FIGS. 16 to 18 are diagrams for explaining processing of determining a sidewalk along which the user is walking based on map matching. FIGS. 16 to 18 illustrate two buildings, sidewalks provided along the sides of the buildings, and a track of a positioning result obtained by a satellite positioning system such as a GPS. Here, a case where which of the sidewalks the user has walked is determined by performing map matching when the track of the positioning result as illustrated in FIG. 16 is obtained will be considered.

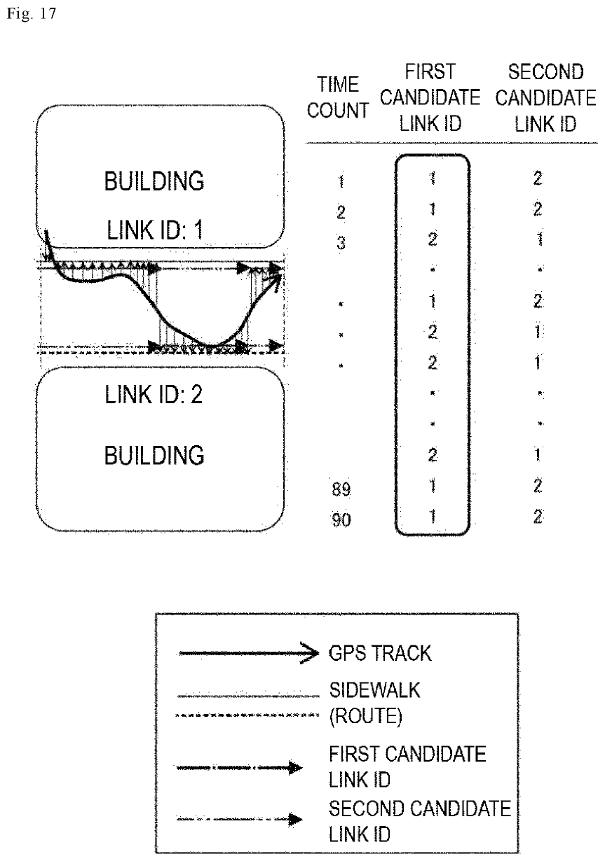

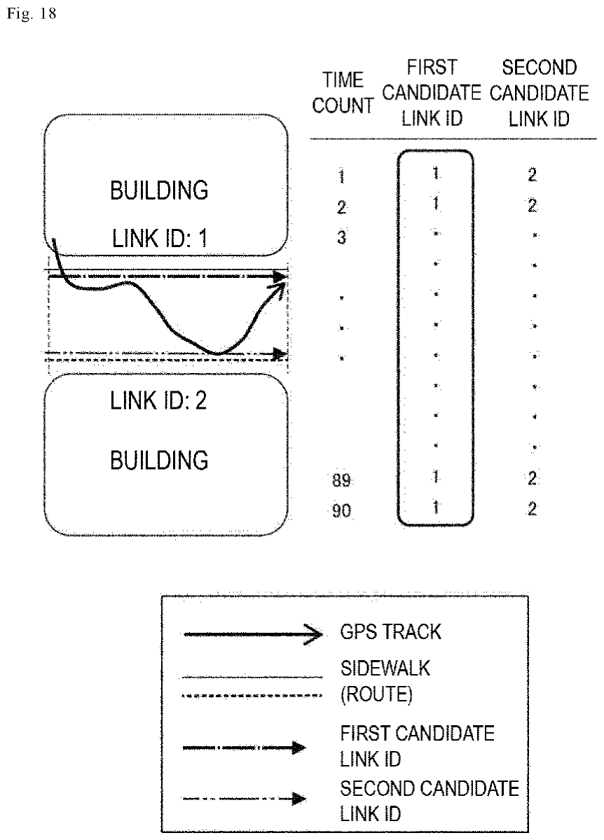

FIG. 17 illustrates a first candidate and a second candidate of a walking network obtained at every positioning time count. Here, a sidewalk at a shorter distance to the current position is defined as the first candidate, and a side walk at a longer distance from the current position is defined as the second candidate. The switching determination device 10 determines a timing at which the walking route is switched using time-series data of the first candidate as an input. FIG. 18 illustrates an example in which the switching determination device 10 has determined that the user has walked along a sidewalk with an ID=1 at all the positioning time counts in the switching determination performed by the switching determination device 10.

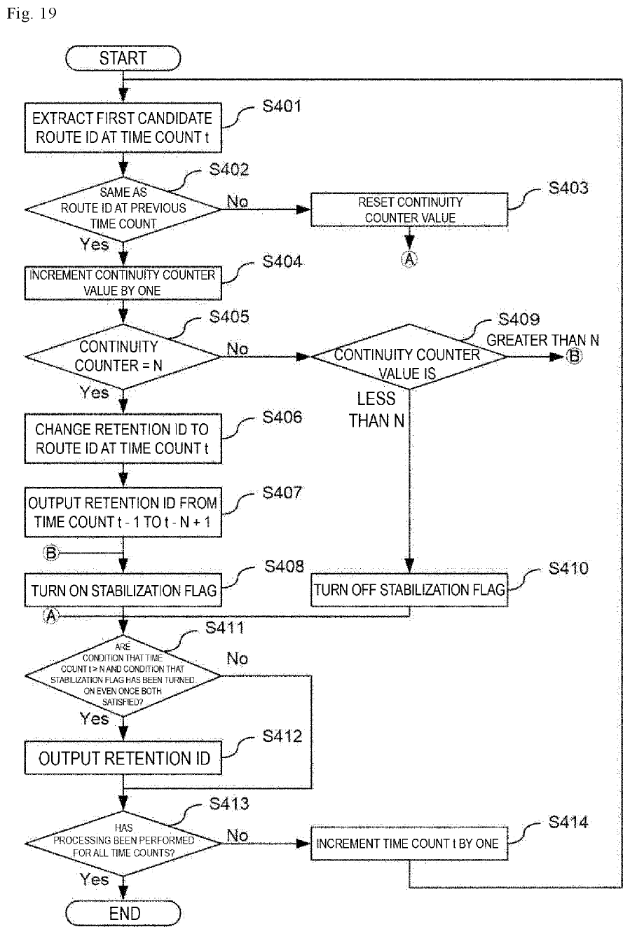

FIG. 19 is a flowchart illustrating an example of a flow of the switching determination processing performed by the switching determination device 10. The switching determination processing is performed by the CPU 11 reading the switching determination program from the ROM 12 or the storage 14 and developing and executing the switching determination program in the RAM 13.

The input time-series data is a first candidate route ID selected through map matching in this case. The CPU 11 extracts the first candidate route ID at the time count t in the input time-series data (Step S401). An initial value oft is defined as zero.

After Step S401, the CPU 11 determines whether the route ID extracted in Step S401 is the same as a route ID extracted at the previous time count (Step S402). If the route ID extracted in Step S401 is not the same as the route ID extracted at the previous time count (Step S402: No), the CPU 11 resets the continuity counter value to zero (Step S403). Processing after Step S403 will be described later. On the other hand, if the route ID extracted in Step S401 is the same as the route ID extracted at the previous time count (Step S402: Yes), the CPU 11 increments the continuity counter value by one (Step S404).

After Step S404, the CPU 11 determines whether the continuity counter value is equal to a predetermined threshold value N (Step S405). If the continuity counter value is equal to the predetermined threshold value N (Step S405: Yes), the CPU 11 changes the retention ID to the route ID at the time count t (Step S406). The retention ID is an example of the retention value. After Step S106, the CPU 11 outputs the retention ID from a time count t−1 to a time count t−N+1 (Step S407). After Step S407, the CPU 11 sets the stabilization flag to ON (Step S408). A value corresponding to ON of the stabilization flag is, for example, 1.

If the continuity counter value is not equal to the predetermine threshold value N (Step S405: No) as a result of the determination in Step S405, the CPU 11 determines whether the continuity counter value is equal to or greater than the predetermined threshold value N (Step S409). In a case in which the continuity counter value is greater than the predetermined threshold value N, the CPU 11 sets the stabilization flag to ON (Step S408). On the other hand, in a case in which the continuity counter value is less than the predetermined threshold value N, the CPU 11 sets the stabilization flag to OFF (Step S410). A value corresponding to OFF of the stabilization flag is, for example, 0.

After Step S403, Step S408, or Step S410, the CPU 11 determines whether or not the time count t is equal to or greater than the predetermined threshold value N and whether the stabilization flag has been turned on even once (Step S411). If the time count t is equal to or greater than the predetermined threshold value N and the stabilization flag has been turned on even once (Step S411: Yes), the CPU 11 outputs the retention ID (Step S412). On the other hand, if the time count t is less than the predetermined threshold value N or if the time count t is equal to or greater than the predetermined threshold value N and the stabilization flag has not been turned on even once (Step S411: No), the CPU 11 skips the processing in Step S412 because no retention ID is present.

After Step S411 or Step S412, the CPU 11 determines whether or not the process at all the time counts in the time-series data has been done (Step S413). If the processing at all the time counts in the time-series data has been done (Step S413: Yes), the CPU 11 ends the series of the processes. On the other hand, if the processing at all the time counts in the time-series data has not been done (Step S413: No), the CPU 11 increments the time count t by one (Step S414). After Step S414, the CPU 11 return to the processing of extracting the route ID at the time count tin the input time-series data in Step S401.

The switching determination device 10 can stably determine the timing at which the values are switched from the input time-series data by executing the series of operations illustrated in FIG. 19. The switching determination device 10 can stably determine the timing at which the values are switched and can thus contribute to accurate determination of a walking position of the user.

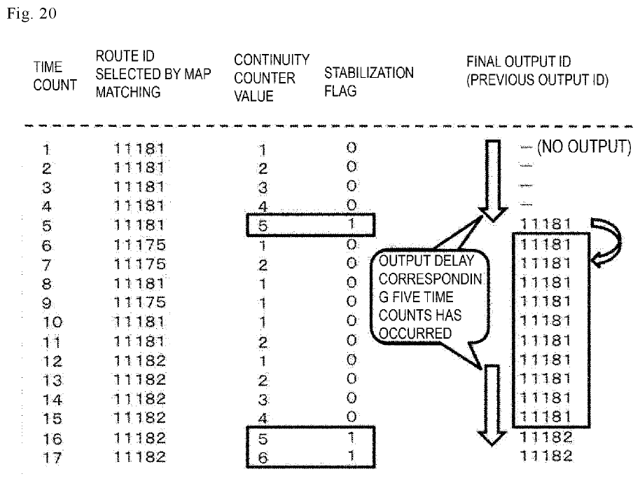

FIG. 20 is a diagram for explaining the switching determination processing performed by the switching determination device 10. FIG. 20 illustrates a time count, a first candidate route ID acquired by the switching determination device 10 at each time count, a continuity counter value, a stabilization flag, and a route ID to be finally output by the switching determination device 10.

In the example illustrated in FIG. 20, the threshold value N is set to five. All first candidate route IDs acquired by the CPU 11 are “11181” and are the same at the time count t=1 to 5. Thus, the CPU 11 sets the stabilization flag to 1 (ON) and outputs the route ID “11181” at the timing of the time count t=5. Because the acquired first candidate route ID becomes a value that is different from an ID at the previous time count at the following timing of the time count t=6, the CPU 11 sets the stabilization flag to 0 (OFF). However, no change occurs in the route ID to be output. Although the first candidate route ID slightly changes thereafter, the CPU 11 curbs the unstable switching of the output value and continuously outputs “11181”, which is the route ID at the timing of the time count t=5.

Thereafter, all the first candidate route IDs acquired by the CPU 11 at the time count t=12 to 16 are “11182” and are the same. Then, the CPU 11 sets the stabilization flag to 1 (ON) at the timing of the time count t=16. Then, the CPU 11 switches the output of the route ID from “11181” to “11182” at the timing of the time count t=16.

Because the threshold value N is five in the example illustrated in FIG. 20, the stabilization flag is set to 1 (ON) for the first time, and the route ID is output, if the same first candidate route ID continues five times straight. Thus, a delay corresponding to five time counts at minimum occurs in the output.

Thus, the CPU 11 outputs the retained route ID from the time count t−1 to the time count t−N+1 as in Step S407 in FIG. 19 at the timing at which the stabilization flag is set to 1 (ON).

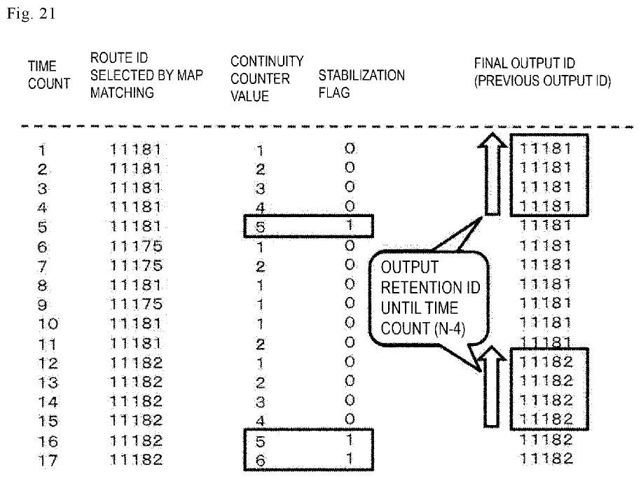

FIG. 21 is a diagram for explaining the switching determination processing performed by the switching determination device 10. FIG. 21 illustrates a time count, a first candidate route ID acquired by the switching determination device 10 at each time count, a continuity counter value, a stabilization flag, and a route ID finally output by the switching determination device 10.

In the example in FIG. 21, the CPU 11 sets the stabilization flag to 1 (ON) at the timing of the time count t=5 similarly to the example in FIG. 20. Then, the CPU 11 outputs the route ID “11181” as an output at the time count t=1 to 4 at this timing.

In the example in FIG. 21, the CPU 11 sets the stabilization flag to 1 (ON) at the timing of the time count t=16 similarly to the example in FIG. 8. Then, the CPU 11 outputs the route ID “11182” as an output at the time count t=12 to 15 at this timing.

In this manner, the CPU 11 can eliminate a delay of the output in response to the input, by outputting the route ID from the time count t−1 to the time count t−N+1 as in Step S407 in FIG. 19 at the timing at which the stabilization flag is set to 1 (ON).

Note that the switching determination processing executed by the CPU reading software (program) in the aforementioned embodiment may be executed by any of various processors other than the CPU. Examples of the processor in such a case include a programmable logic device (PLD) such as a field-programmable gate array (FPGA) the circuit configuration of which can be changed after manufacturing, a dedicated electric circuit such as an application specific integrated circuit (ASIC) that is a processor having a circuit configuration designed dedicatedly for executing the specific processing, and the like. Also, the switching determination processing may be executed by one of these various processors or may be executed by a combination of two or more processors of the same type or different types (for example, a plurality of FPGAs and a combination of a CPU and an FPGA). More specifically, the hardware structure of such various processors is an electrical circuit obtained by combining circuit devices such as semiconductor devices.

Although the aspects in which the switching determination program is stored (installed) in advance in the storage 14 have been described in the aforementioned embodiments, the present invention is not limited thereto. The program may be provided in the form of being stored in a non-transitory storage medium such as a compact disk read only memory (CD-ROM), a digital versatile disk read only memory (DVD-ROM), or a universal serial bus (USB) memory. The program may be in a form that is downloaded from an external apparatus via a network.

With respect to the above embodiment, the following supplements are further disclosed.
Supplementary Item 1
A switching determination device including:
a memory; and
at least one processor connected to the memory,
in which the processor is configured to
receive an input of time-series data,
compare a value of the input time-series data at a first time count with a value of the input time-series data at a second time count just before the first time count, and
increment a continuity counter value in a case in which the value of the input time-series data at the first time count and the value of the input time-series data at the second time count conform to each other, or reset the continuity counter value in a case in which the value of the input time-series data at the first time count and the value of the input time-series data at the second time count do not conform to each other, and
set a value of the time-series data at a time count at which the continuity counter value becomes equal to or greater than a threshold value as a retention value and output the retention value by tracing back to a time count that is continuously incremented until the threshold value is reached after the continuity counter value is reset.
Supplementary Item 2
A non-transitory storage medium configured to store a program that can be executed by a computer to execute switching determination processing, the switching determination processing including:
receiving an input of time-series data;
comparing a value of the input time-series data at a first time count with a value of input the time-series data at a second time count just before the first time count and incrementing a continuity counter value in a case in which the value of the input time-series data at the first time count and the value of the input time-series data at the second time count conform to each other or resetting the continuity counter value when the value of the input time-series data at the first time count and the value of the input time-series data at the second time count do not conform to each other; and
setting a value of the input time-series data at a time count at which the continuity counter value becomes equal to or greater than a threshold value as a retention value and outputting the retention value by tracing back to a time count that is continuously incremented until the threshold value is reached after the continuity counter value is reset.

### REFERENCE SIGNS LIST

10 Switching determination device
101 Input unit
102 Continuity counter value
103 Retention value output unit
104 Determination unit

1. A switching determination device comprising a circuit configured to execute a method comprising:
receiving an input time-series data obtained by continuously receiving radio signals;
comparing a value of the input time-series data at a first time count with a value of the input time-series data at a second time count just before the first time count;
at least either:
incrementing a continuity counter value in a case in which the value of the input time-series data at the first time count and the value of the input time-series data at the second time count conform to each other, or
resetting the continuity counter value in a case in which the value of the input time-series data at the first time count and the value of the input time-series data at the second time count do not conform to each other; and
setting a value of the input time-series data at a time count at which the continuity counter value becomes equal to or greater than a threshold value as a retention value and output the retention value until the next time the continuity counter value becomes equal to or greater the threshold value.

2. The switching determination device according to claim 1, the circuit further configured to execute a method comprising:
outputting the retention value by tracing back an amount of a time count corresponding to the threshold value from the time count at which the continuity counter value becomes equal to or greater than the threshold value.

3. The switching determination device according to claim 1,
wherein the continuity counter value is distinct from another continuity counter value in accordance with a type of the radio signals, and
the circuit further configured to execute a method comprising:
determining whether a place where a radio signal of the radio signals has been received is indoor or outdoor based on a result of the comparing the value of the input time-series data based on the other continuity counter value.

4. The switching determination device according to claim 3,
wherein the place is outdoor when the continuity counter value becomes equal to or greater than a first threshold value through processing of the continuity counter value on a wireless signal transmitted from a satellite positioning system, and
wherein the place is indoor when the continuity counter value becomes equal to or greater than a second threshold value through processing of the continuity counter value on a Bluetooth (trade name) low energy (BLE) signal or a radio signal from a wireless local area network (LAN) access point.

5. The switching determination device according to claim 1, the circuit further configured to execute a method comprising:
determining a place where the radio signals have been received based on a result of the comparing the value of the input time-series data based on another continuity counter value.

6. The switching determination device according to claim 2,
wherein the radio signals include a radio signal transmitted from a satellite positioning system, and
the circuit further configured to execute a method comprising:
determining a change in traveling direction based on a result of the comparing the value of the input time-series data based on the continuity counter value.

7. A computer-implemented method for determining switching, the method comprising:
receiving an input time-series data obtained by continuously receiving radio signals;
comparing a value of the input time-series data at a first time count with a value of the input time-series data at a second time count just before the first time count, and incrementing a continuity counter value in a case in which the value of the input time-series data at the first time count and the value of the input time-series data at the second time count conform to each other, or resetting the continuity counter value in a case in which the value of the input time-series data at the first time count and the value of the input time-series data at the second time count do not conform to each other; and
setting a value in the input time-series data at a time count at which the continuity counter value becomes equal to or greater than a threshold value as a retention value and outputting the retention value by tracing back to a time count that is continuously incremented until the threshold value is reached after the continuity counter value is reset.

8. A computer-readable non-transitory recording medium storing computer-executable program instructions that when executed by a processor cause a computer system to execute a method comprising:
receiving an input time-series data obtained by continuously receiving radio signals;
comparing a value of the input time-series data at a first time count with a value of the input time-series data at a second time count just before the first time count, and incrementing a continuity counter value in a case in which the value of the input time-series data at the first time count and the value of the input time-series data at the second time count conform to each other, or resetting the continuity counter value in a case in which the value of the input time-series data at the first time count and the value of the input time-series data at the second time count do not conform to each other; and
setting a value in the input time-series data at a time count at which the continuity counter value becomes equal to or greater than a threshold value as a retention value and outputting the retention value by tracing back to a time count that is continuously incremented until the threshold value is reached after the continuity counter value is reset.

9. The switching determination device according to claim 2,
wherein the continuity counter value is distinct from another continuity counter value in accordance with a type of the radio signals, and
the circuit further configured to execute a method comprising:
determining whether a place where a radio signal of the radio signals has been received is indoor or outdoor based on a result of the comparing the value of the input time-series data based on the other continuity counter value.

10. The computer-implemented method according to claim 7, further comprising:
outputting the retention value by tracing back an amount of a time count corresponding to the threshold value from the time count at which the continuity counter value becomes equal to or greater than the threshold value.

11. The computer-implemented method according to claim 7,
wherein the continuity counter value is distinct from another continuity counter value in accordance with a type of the radio signals, and
the method further comprising:
determining whether a place where a radio signal of the radio signals has been received is indoor or outdoor based on a result of the comparing the value of the input time-series data based on the other continuity counter value.

12. The computer-implemented method according to claim 7, further comprising:
determining a place where the radio signals have been received based on a result of the comparing the value of the input time-series data based on another continuity counter value.

13. The computer-readable non-transitory recording medium according to claim 8, the computer-executable program instructions when executed further causing the system to execute a method comprising:
outputting the retention value by tracing back an amount of a time count corresponding to the threshold value from the time count at which the continuity counter value becomes equal to or greater than the threshold value.

14. The computer-readable non-transitory recording medium according to claim 8, wherein the continuity counter value is distinct from another continuity counter value in accordance with a type of the radio signals, and
the computer-executable program instructions when executed further causing the system to execute a method comprising:
determining whether a place where a radio signal of the radio signals has been received is indoor or outdoor based on a result of the comparing the value of the input time-series data based on the other continuity counter value.

15. The computer-readable non-transitory recording medium according to claim 8, the computer-executable program instructions when executed further causing the system to execute a method comprising:
determining a place where the radio signals have been received based on a result of the comparing the value of the input time-series data based on another continuity counter value.

16. The computer-implemented method according to claim 10,
wherein the continuity counter value is distinct from another continuity counter value in accordance with a type of the radio signals, and
the method comprising:
determining whether a place where a radio signal of the radio signals has been received is indoor or outdoor based on a result of the comparing the value of the input time-series data based on the other continuity counter value.

17. The computer-implemented method according to claim 11,
wherein the place is outdoor when the continuity counter value becomes equal to or greater than a first threshold value through processing of the continuity counter value on a wireless signal transmitted from a satellite positioning system, and
wherein the place is indoor when the continuity counter value becomes equal to or greater than a second threshold value through processing of the continuity counter value on a Bluetooth (trade name) low energy (BLE) signal or a radio signal from a wireless local area network (LAN) access point.

18. The computer-implemented method according to claim 12,
wherein the radio signals include a radio signal transmitted from a satellite positioning system, and
the method further comprising:
determining a change in traveling direction based on a result of the comparing the value of the input time-series data based on the continuity counter value.

19. The computer-readable non-transitory recording medium according to claim 14,
wherein the place is outdoor when the continuity counter value becomes equal to or greater than a first threshold value through processing of the continuity counter value on a wireless signal transmitted from a satellite positioning system, and
wherein the place is indoor when the continuity counter value becomes equal to or greater than a second threshold value through processing of the continuity counter value on a Bluetooth (trade name) low energy (BLE) signal or a radio signal from a wireless local area network (LAN) access point.

20. The computer-readable non-transitory recording medium according to claim 15, wherein the radio signals include a radio signal transmitted from a satellite positioning system, and
the computer-executable program instructions when executed further causing the system to execute a method comprising:
determining a change in traveling direction based on a result of the comparing the value of the input time-series data based on the continuity counter value.
